(19) United States
(12) Patent Application Publication
(10) Pub. No.: US 2008/0127284 A1
(43) Pub. Date: May 29, 2008

(54) ELECTRONIC MOVIE TITLE HIRE METHOD, SYSTEM & DEVICE THEREFOR

(75) Inventor: Jim Kouniniotis, Double Bay (AU)

Correspondence Address: PILLSBURY WINTHROP SHAW PITTMAN, LLP, P.O. BOX 10500, MCLEAN, VA, 22102, US

(73) Assignees: Jim Kouniniotis, Double Bay (AU); Sara Delpopolo, Double Bay (AU)

(21) Appl. No.: 11/778,507

(22) Filed: Jul. 16, 2007

(30) Foreign Application Priority Data
Nov. 27, 2006 (AU) 2006 906 609

(51) Int. Cl. H04N 7/173

(52) U.S. Cl. 725/91

(57) ABSTRACT

A method of a movie rental vendor hiring one or more movie titles in electronic format to a movie renter includes connecting a portable personal storage device to a vendor computer system, and registering the storage device and one or more associated authorized users with the vendor computer system and configuring the storage device to receive one or more movie titles in electronic format. At least one of the authorized users select one or more movie titles from a plurality thereof available for rent by the vendor and then they download the selected one or more movie titles from the vendor computer system to the storage device. The method further includes exchanging monetary payment from the renter to the vendor for the downloaded movie title(s), the magnitude of said payment depending on the downloaded movie title(s) and the length of time of rental for each downloaded title(s) and/or a number of permitted viewings of each downloaded title. The storage device may be connected to an input of television display device for viewing of the downloaded movie title(s) over a predetermined period or a predetermined number of viewings. The renter can the play the downloaded movie title(s) on the television display, and the storage device may be configured to store data unrelated to the downloaded movie title(s) and/or to provide functions in addition to receiving, storing and displaying downloaded movie title(s).

### BACKGROUND

This application claims priority under 35 U.S.C. §119(a) to Australian Application Serial No. 2006 906 609 filed on Nov. 27, 2006, the entire contents of which are incorporated herein by reference. This disclosure relates, in one aspect, to electronic movie title hiring from a movie rental vendor to a movie renter and, in particular, to a method, system and devices to facilitate the same. In a further aspect, this disclosure relates to a method to download books or other information in a digital form, for example, an electronic book (“e-book”) or electronic magazine (“e-zine”).

Various aspects of embodiments of the invention have been developed primarily for use by conventional video/DVD movie rental stores and will be described hereinafter with reference to this application. However, it will be appreciated that this disclosure is not limited to this particular field of use.

Movie title rental stores have been long established. The take-up of video cassette recorders and subsequently DVD players has allowed the movie title rental industry to flourish. In practice, a movie title rental vendor acquires one or more copies of each movie title available for rental to clients of their store, or stores if they own more than one. At least one copy of each movie title available for hire is displayed within the store.

Unfortunately, when a new movie title is released to the rental market, it may be particularly popular requiring the rental vendor to acquire a significant number of copies at a corresponding significant expense. The rental store must also have sufficient area to allow the display of all available movie titles to potential renters. In addition to these problems, damaged or unreturned rental movie titles add a relatively significant layer of expense not only for the damaged or unreturned disks or tapes, but in administrative time following this up and lost income on rental of the disks or tapes until they are replaced.

As alternatives to conventionally known movie title rental stores, other vendors have developed systems of their own. Such systems include the mail order or internet ordering of movie titles for rent in which the ordered title(s) are delivered to a user via the postal system and are returned the same way after use. Unfortunately, relatively large numbers of movie title disks are required and these are often damaged or unreturned. Of course, overhead costs to produce the disks, process the rental thereof and mail transport adds a not insignificant expense.

In the alternative, it is now becoming increasingly common for movie title rental vendors to allow users to select and download pre-determined movie titles over an internet connection. In such systems, the user receives the movies in their computer. Typically, however, people wish to watch movie titles on a dedicated television display device as most computer displays that people may own are either not large enough for viewing a hired movie, are not in a household viewing room or the computer displays simply cannot properly display moving images, for example. Furthermore, it is clear that not everyone owns or has access to a properly configured computing device nor might they desire this.

As an augmentation to the hiring of movie titles in conventional movie title hire shops, U.S. Pat. No. 7,020,636 (Matsushita Electrical Industrial, Co. Ltd.) discloses an alternative movie title rental system. In this system, a DVD containing a pre-selected movie title is rented from the video rental store. As well as providing the user with the DVD containing the movie, a separate IC card is additionally provided to the user which validates the use of the DVD in a specially configured DVD player disposed at the user's home.

In use, the user inserts the IC card into a specially configured DVD player which configures the DVD player to allow the hired DVD movie title to be played back by that player. Data on the IC card controls the length of time or number of viewings that can be made by a user of the hired DVD movie.

Unfortunately, this system most usefully addresses pirating issues associated with the rental of movie titles and still requires a relatively large shop or display environment and the disks are still likely to suffer damage or possibly be unreturned.

### SUMMARY

Various aspects of embodiments of this disclosure provide a method of a movie rental vendor hiring one or more movie titles in an electronic format to a movie renter, and a system and device therefor that overcomes or substantially ameliorates the above problems of the prior art, or to provide a useful alternative.

According to a various aspects of this disclosure, a method of movie rental vendor hiring of one or more movie titles in electronic format to a movie renter includes connecting a portable personal storage device to a vendor computer system; registering said storage device and one or more associated authorized users with said vendor computer system and configuring said storage device to receive one or more movie titles in electronic format; at least one of said authorized users selecting one or more movie titles from a plurality thereof available for rent by said vendor; downloading said selected one or more movie titles from said vendor computer system to said storage device; exchanging or providing a monetary payment from said renter to said vendor for said downloaded movie title(s), the magnitude of said payment depending on the downloaded movie title(s) and the length of time of rental for each downloaded title(s) and/or a number of permitted viewings of each downloaded title; connecting said storage device directly to an input of television display device for viewing of said downloaded movie title(s) over a predetermined period or a predetermined number of viewings thereof, and playing said downloaded movie title(s) on said television display; wherein said storage device is configured to store data unrelated to said downloaded movie title(s) and/or to provide functions in addition to receiving, storing and displaying downloaded movie title(s).

According to another aspect of this disclosure, a system is provided upon which a method of this disclosure can be practiced.

According to yet another aspect, a portable personal storage device can be used to receive, store and display a movie title(s) downloaded thereon in accordance with a method of this disclosure.

It can therefore be seen that there is advantageously provided a method, a system and device therefor, by which a movie hire vendor can hire one or more movie titles in electronic format to a registered user whereby the movie title may be stored electronically either in a vendor shop or a kiosk and/or on a third-party property being electronically accessible, thereby reducing the number of copies of individual movie titles and amount of space required to store and present them.

The method also overcomes the disadvantage of damaged and unreturned DVDs as the registered user stores the movie titles electronically in their own personal device and the electronic files simply expire after some time or some number of viewings. Further, it is also particularly advantageous to provide a system which does not require the use of a computer to play back a movie title and which does not require relatively expensive and specialized components or playback equipment to be purchased by or provided to the user.

### BRIEF DESCRIPTION OF THE DRAWINGS

Various embodiments of the disclosure will now be described, by way of example only, with reference to the accompanying drawings in which:

FIG. 1 is a flow diagram of a method of a movie rental vendor hiring one or more movie titles in electronic format to a movie renter in accordance with an embodiment;

FIG. 2 is a schematic block diagram of a system upon which the method of an embodiment can be practiced; and

FIG. 3 is a schematic block diagram of a system upon which a movie hired by the method of the embodiment of FIG. 1 can be viewed by a user.

### DETAILED DESCRIPTION

Referring to the drawings generally, like reference numerals are used throughout the description of the preferred embodiment to refer to like components and/or steps and/or features unless the contrary is expressly stated.

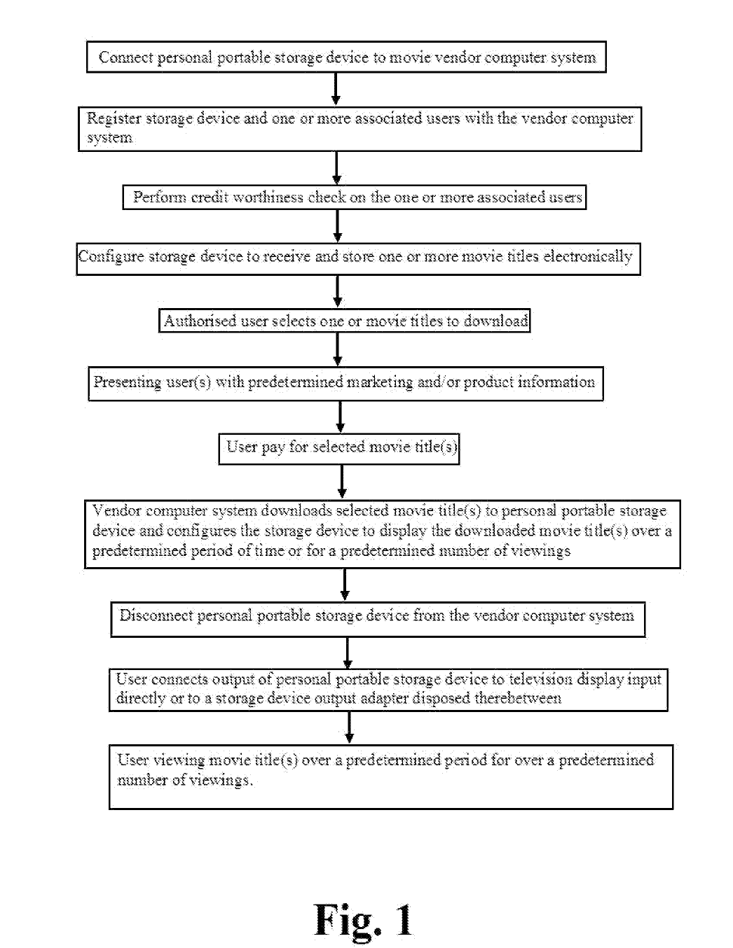

Referring to FIG. 1, a flow diagram of an embodiment of the movie rental vendor hiring method for one or more movie titles in electronic format to a movie renter or user is illustrated. In the method, a portable personal storage device 260 in the form of a USB thumb drive storage device belonging to a user for their authorized user, for example, is connected to a movie rental vendor computer system 200.

The USB device 260 may be a high speed USB device operating under the USB 2.0 protocol at approximately 480 Mbits/s, however it will be appreciated the storage device 260 may operate under the USB 1.1 protocol with a full speed of approximately 12 Mbits/s. Once the storage device 260 is connected to the vendor computer system 200 a driver to support the device is loaded into computer system 200, if not already loaded. In various aspects of this disclosure, the USB device 260 may be configured to operate isochronous transfers from the USB device 260 which allows time sensitive movie (or other) data to be continuously periodically transferred with a predetermined minimum bandwidth and battery. The computer system 200 is configured for undertaking all transactions with the USB storage device 260 using a token based protocol.

The USB storage device 260 may be registered with the vendor computer system 200 together with one or more registered users to be associated with the USB storage device 260. During the registration process, the USB storage device 260 may be configured to receive one or more movie titles and a predetermined portion 268 of the USB storage device memory 263 may be partitioned for access and use only by the vendor computer system 200. The partitioned memory 268 may be configured for containing data indicative of the registration of the device 260 and any one or more authorized users with the vendor computer system 200. The partitioned portion 268 of the USB storage device memory 263 may be configured for controlling the output of movie titles stored on the USB storage device 260 for display. That is, the USB storage device 260 can control the uploading of movie data therefrom, including any limitations on the viewing of the stored movie title(s) and the existence of any digital rights management information.

During registration, particulars of one or more authorized users such as names, addresses, ages, personal references, or any other preferred information may be stored on the vendor computer system 200 to allow use only by that person. A predetermined personal identification number (“PIN”) code or other identifier can be associated with one or more authorized users to confirm the identity of that person in transacting with the movie rental vendor, the PIN code information may be covertly stored on the vendor computer system 200 and/or in the partitioned memory portion 268 of the USB storage device 260.

The partitioned memory portion 268 of the USB storage device 260 may also be configured to store data indicative of movie rental history of one or more of the authorized users either within the USB memory device 260 or in the vendor computer system 200.

During the registration of the one or more authorized users, the vendor computer system 200 may be configured to establish a connection with a credit reference agency computer system 281 and to abort the registration of the user(s) should they not be credit worthy.

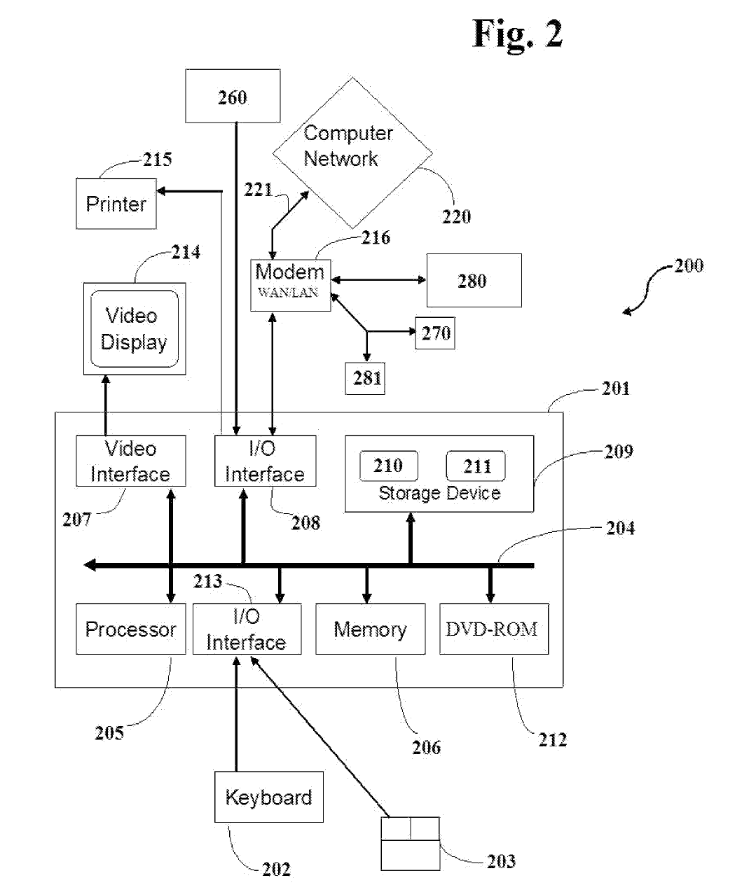

An authorized user may then select one or more movie titles from a plurality of movie titles available for hire by the vendor. As it is described below with reference to FIG. 2 for a system for implementing the method of FIG. 1, the user can select the one or more movie titles presented either in a vendor shop or as presented on a display at the vendor kiosk at some other location. It will be appreciated the vendor kiosk(s) can also be located in or adjacent the movie rental vendor's shop.

Once the user has selected the movie title(s) they wish to hire for viewing, the movie title(s) in electronic form may be downloaded to the USB memory device 260. The details of the downloaded movie title(s) are also recorded on the vendor computer system 200 and in the partitioned memory portion 268 of the USB storage device 260. The vendor computer system 200 undertakes the additional step, just prior to downloading the movie title(s), of validating the registration of the USB storage device 260 and the authorized user. For example, the device 260 may no longer be registered, or the authorized user may not be registered for hiring certain classifications of movie titles, for example.

It will also be appreciated that during registration of the device 260, one or more personal identification numbers associated with respective one or more authorized users of the device 260 can be ascribed such that entry of a personal identification number verifies the identity and/or account information of an authorized user. The personal identification numbers can be stored in the partitioned memory 268 and/or on the vendor computer system 200. Not only may the personal identification numbers be used as a substitute for identification, the vendor computer system 200 may be configured to use the personal identification numbers also as a “parental lock” whereby authorized users that are restricted in their viewing by age will be accordingly identified by the vendor computer system so that inappropriate movie titles cannot be downloaded to the storage device 260. Of course, it will be appreciated that a single personal identification number can be associated with a plurality of authorized users of the storage device 260.

Either before or during or after downloading the selected movie titles to the user's USB storage device 260, the user can be presented with promotional information depending on the selected movie title(s) and/or any of their registration details and/or their previous movie rental title history (if any). The promotional information can be used to suggest additional movie titles or other related or unrelated products and/or services.

Also, either before, during, or after downloading the selected movie titles to the USB storage device 260, the user may remit payment to the movie hire vendor for the downloaded titles. This can be effected either in a conventional manner using cash or check, or can be conducted over an electronic funds transfer at point of sale (EFTPOS) transaction network 270, or by debiting an account associated with the user (for example, a mobile telephone account) according to the selected and downloaded movie titles.

The magnitude of the monetary payment may be dependent upon the number of movie titles downloaded, as well as the length of time and/or number of times each movie title is to be viewed. The vendor computer system 200 configures the partitioned memory portion 268 of the USB storage device 260 to cause the downloaded movie titles to become electronically inaccessible after a predetermined period of time or after a predetermined number of uploaded viewings.

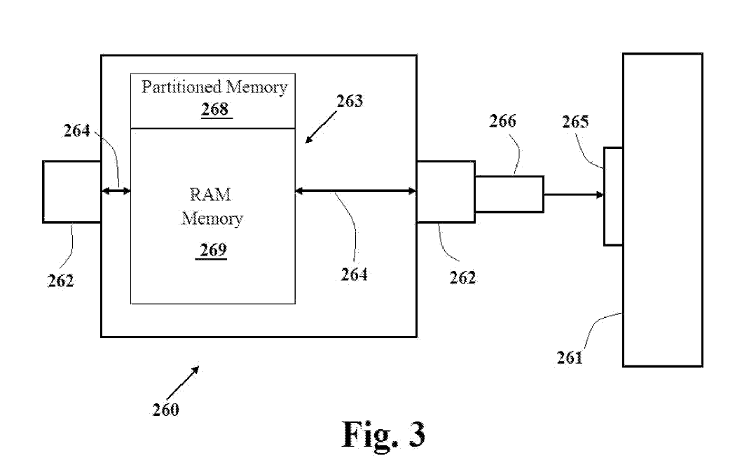

The USB storage device 260 is then disconnected from the vendor computer system 200 and the user has a predetermined period of time or predetermined number of viewings of each downloaded movie title. To view a downloaded movie title, the user connects the output 262 of the USB storage device to a conventional television display input 265 connection, either directly or indirectly. For example, as shown in FIG. 3 and described further below, the output 262 of the USB storage device 260 can be connected to a display adapter 266 disposed intermediate the television display input 265 and the USB storage device output 262. Likewise, the storage device 260 can be connected to a television input of a television interface disposed in a computer device (not illustrated).

It will be appreciated that whilst the USB storage device 260 may be configured to operate in accordance with one or more steps of the method illustrated in the flow diagram of FIG. 1, the USB storage device 260 can be used for any other memory storage and retrieval task in addition to the receipt, storage and display of downloaded movie titles from the vendor computer system 200.

In one aspect, the vendor computer system 200 downloads movie titles to the USB storage device 260 in a format which can be directly input into the television display input 265 for viewing by the authorized user. Such a format includes MP3 and DVD file formats, for example. In cases where an adapter 266 is disposed intermediate a television display input 265 and the USB storage device output 262, the movie titles stored on the USB storage device 260 can be stored in any preferred format and converted to a format compatible for input in the conventional television display 261 by the storage device output adapter 266.

It will be appreciated that the USB storage device can be connected to an RF connection, including a microwave connection, a component video connection, a coaxial connection, a digital video connection, an optical connection, a USB connection, an IEEE 1394 FireWire connection, or other conventional television display input connection 265. That is, the USB storage device 260 or the storage device output 262 are configured to connect directly to one of the standard inputs 265 on a conventional television display 261 for viewing of downloaded movie titles thereon. The storage device output adaptor 266 can simply act as a plug adapter without modifying the stored movie title(s) for playing on the television display 261.

As noted above, the vendor computer system 200 can be disposed at a movie title hire store or a remote location or on the premises of a third-party and be accessible by an interface thereto if preferred. Furthermore, the vendor computer system 200 can be configured to communicate to one or more remote movie title storage database(s) 280 for downloading on to the portable personal storage device 260. That is, the authorized users can hire selected movie titles from a movie title hire shop premises or from a system including a self-service kiosk disposed in a remote location where the available movie titles are stored on one or more databases 280 that are remote or local to the shop or kiosk. Of course, it will be appreciated that such self-serve kiosks can be disposed within the movie rental store to provide an additional point of sale for the user.

It will be appreciated that the vendor computer system can be configured to additionally provide copies of movie titles on DVD discs that are created by the vendor computer system in response to a specific request by a user. That is, the vendor computer system 200 in communication with the movie title data base 280 can be configured to select and download to the vendor computer system 200 one or more selected movie titles. Although not illustrated in the drawings, the movie title can be burnt onto a DVD disc by means of a DVD writing device to allow the authorized users, or other users indeed, the opportunity to purchase movie titles.

In this way, the movie rental vendor does not need to maintain any copies of any DVD discs and a simple and relatively inexpensive selection of blank DVDs can be provided so as to be burnt with movie titles as selected. Thus, the significant investment required in shelf space or copies of discs having movie titles on them is overcome.

It will also be appreciated that in cases where the vendor computer system 200 dispenses DVD discs with movie titles downloaded from the database 280, that disposable or limited use blank DVDs can be provided so as to have movie titles burnt onto them from database 280 by the vendor computer system 200. In such cases, pre-determined use of the burnt DVDs will cause the data to be corrupted or re-written so as to restrict the number of viewings of such a burnt DVD.

In respect of the portable personal storage device 260, it will be appreciated that in one aspect of various embodiments, a USB storage device 260 and a storage device adaptor 266 are described and used. However, it will be appreciated that any preferred portable personal storage device such as USB flash RAM (as described) or a USB hard disk drive can be used, as can a mobile telephone having sufficient memory and being suitably configured to communicate with the vendor computer system 200, or a personal digital assistant or other portable media player or portable electronic storage device. Depending on the portable personal storage device 260, any preferred connection between it and the vendor computer system 200 can be used. Such a connection can include a USB connection, IEEE FireWire connection, infrared connection, radio-frequency connection, a microwave connection or other conventional wireless or cable connection means operating a preferred token-based protocol can be used as preferred.

The method of FIG. 1 is preferably practiced using a movie vendor computer system 200, such as that shown FIG. 2. The processes of FIG. 1 may be implemented as software, such as an application program executed within the computer system 200. In particular, the steps of method of FIG. 1 are effected by instructions in the software that are carried out by the computer. The software may be divided into two separate parts; one part for carrying out the FIG. 1 methods; and another part to manage the user interface between the latter and the user.

The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer may be used to configure an apparatus to carry out one or more steps of the method depicted in FIG. 1, in accordance with various aspects of embodiments of this disclosure.

The computer system 200 comprises a computer module 201, input devices such as a keyboard 202 and mouse 203, and output devices including a printer 215 and a display device 214. A Modulator-Demodulator (Modem) transceiver 216 is used by the computer module 201 for communicating to and from a communications network 220. For example, the computer module 201 is connectable via a telephone line 221 or other functional medium. The modem 216 can be used to obtain access to the Internet, and other network systems, such as a Local Area Network (LAN) or a Wide Area Network (WAN).

The computer module 201 typically includes at least one processor unit 205, a memory unit 206, for example formed from semiconductor random access memory (RAM) and read only memory (ROM), input/output (I/O) interfaces including a video interface 207, and an I/O interface 213 for the keyboard 202 and mouse 203 and optionally a joystick (not illustrated), and an interface 208 for the modem 216 and for the portable personal storage device 260. A storage device 209 is provided and typically includes a hard disk drive 210 and a floppy drive 211. A magnetic tape drive (not illustrated) or other mass storage device may also be used.

A DVD-ROM drive 212 is typically provided as a non-volatile source of data. The components 205 to 213 of the computer module 201, typically communicate via an interconnected bus 204 and in a manner which results in a conventional mode of operation of the computer system 200 known to those in the relevant art. Examples of computers on which the embodiments can be practiced include IBM-PC's and compatibles, Sun Sparcstations or similar computer systems evolved therefrom.

Typically, the application program of the preferred embodiment is resident on the hard disk drive 210 and read and controlled in its execution by the processor 205. Intermediate storage of the program (and any data from the vendor computer movie databases 260 or from the network 220) may be accomplished using the semiconductor memory 206, possibly in concert with the hard disk drive 210. In some instances, the application program may be supplied to the user encoded on a CD or DVD-ROM or floppy disk and read via the corresponding drive 212 or 211, or alternatively may be ready by the user from the network 220 via the modem device 216.

Still further, the software can also be loaded into the computer system 200 from other computer readable media including magnetic tape, a ROM or integrated circuit, a magneto-optical disk, a radio or infra-red transmission channel between the computer module 201 and another device, a computer readable card such as a PCMCIA card, and the Internet and Intranets including email transmissions and information recorded on websites and the like. The foregoing is merely exemplary of relevant computer readable media. Other computer readable media may be practiced without departing from the scope and spirit of the disclosure.

The method of FIG. 1 may alternatively be implemented in dedicated hardware (“firmware”) such as one or more integrated circuits performing the functions or sub functions of FIG. 1. Such dedicated hardware may include graphic processors, digital signal processors, or one or more microprocessors and associated memories.

In the system of FIG. 2, the MODEM 216 (or WAN/LAN or the like) may also be configured to establish a connection with the electronic funds transfer (EFT) network 270. In this way, payment for the downloaded movie titles can be made electronically in a conventional manner at the time of downloading (before, during or after as preferred). As noted above, a connection can be established between the vendor computer system 200 and a credit reference agency database 281 to verify the credit worthiness of one or more authorized users.

Referring now particularly to FIG. 3, a schematic block diagram of the system upon which a movie hired by the method of the preferred embodiment of FIG. 1 can be displayed by a user is shown. In particular, the USB storage device 260 is shown schematically together with a television display device 261.

The USB storage device 260 is shown schematically as having a USB input/output connection 262 which is shown as separate components but which are integral in a single USB connector. The USB memory device 260 includes a memory portion 263 in communication with the storage device input/output 262 by means of a communications bus 264. The USB storage device memory includes at least two partitions, a first partition 268 being a portioned portion for use by the vendor computer system 200 as described above and by the device 260 to control uploading and downloading of data, for example, and a second portion 269 configured to receive, store and display selected movie titles. It will be appreciated that any preferred portable personal storage device 260 as referred to above can be used is place of the USB storage device if desired.

Once one or more movie titles have been downloaded onto the USB storage device, the device can be connected to the conventional input 265 of the conventional television display 261. In this way, the television display directly receives the movie titles for display on the television. As also shown in the preferred embodiment of FIG. 3, the USB storage device 260 is configured to connect to the input of the storage device output adaptor 266.

The adaptor 266 receives electronic information indicative of the movie title(s) stored in the storage device 260 and either converts the information to a conventional television signal for input into the television display device input 265 or simply acts as a connection adaptor. For example, the adaptor 266 may simply allow a USB connection to be connected to the RF or component video input of the television display 261.

As described above, the USB storage device 260 may be configured to count the number of times a movie title stored thereon has been retrieved for display on the television display device and to deny access to a movie title once it has been displayed a predetermined number of times. Alternatively, the storage device 260 may be configured to internally count down a period of time for which movie titles have been hired. In this way, once a predetermined period of time has elapsed the movie titles stored on the USB storage device 260 become inaccessible.

It will also be appreciated that the vendor computer system 200 can be configured to provide other information for rent, such as e-books. In such cases, the contents of an e-book is transferred to either a DVD disc from database 280 via the vendor computer system 200, or is burnt onto the storage device 260. In this way, the vendor does not need to retain any copies of any books and simply provides electronic copies upon request. Likewise to the case of providing DVD discs with movie titles burnt onto them by the vendor computer system 200, a similar arrangement will occur with an e-book where after a certain number of uses of the disc the data will lose its integrity.

The foregoing describes only various aspects of embodiments of the disclosure, and modifications, obvious to those skilled in the art, can be made thereto without departing from the scope of the disclosed and claimed invention.

What is claimed is:

1. A method of renting one or more movie titles in an electronic format from a movie rental vendor, the method comprising:
providing a vendor computer system;
registering, with said vendor computer system, a storage device operatively connected to the vendor computer system;
registering one or more authorized users with said vendor computer system;
downloading said selected one or more movie titles from said vendor computer system to said storage device in response to a selection by at least one of said authorized users of one or more movie titles from a plurality thereof available for rent by said vendor; and
receiving a monetary payment by said vendor for said downloaded movie title(s), the magnitude of said payment depending on one or more of the downloaded movie title(s), a length of time of rental for each downloaded title(s), and a number of permitted viewings of each downloaded title.

2. The method of claim 1, further comprising configuring said connected storage device to receive one or more movie titles in the electronic format,
said vendor computer system encoding said downloaded movie title(s) such that said storage device is configured during registration to output said title(s) in a format which can be directly input into a television display for viewing by said one or more authorized users thereon.

3. The method of claim 1, further comprising:
connecting a storage device output adapter intermediate a television display input and an output of said storage device; and
configuring said output adapter to convert said downloaded movie title(s) from said output of said storage device into a format which can be directly input into a television display.

4. The method of claim 3, further comprising configuring said storage device output adapter to connect to a television display input in the form of one or more of an RF (radio frequency), component, coaxial, digital, optical, USB, and IEEE 1394 FireWire television display device input connection.

5. The method of claim 1, further comprising partitioning a predetermined portion of a memory of said storage device during registration for access and use only by said vendor computer system, said partitioned storage device memory being configured to contain data indicative of at least said registration of said storage device and said one or more authorized users and to control an output of said movie titles and other electronic data from said storage device.

6. The method of claim 5, further comprising configuring said partitioned memory portion of said storage device to retain data indicative of the movie title rental history of said storage device and/or said one or more authorized users.

7. The method of claim 6, further comprising configuring said vendor computer system to promote pre-selected movie titles and/or other products to said one or more authorized users during movie title selection, said promotion depending on said movie title rental history of said one or more authorized users and information provided during registration.

8. The method of claim 7, wherein said registering said storage device and one or more authorized users includes recording a serial number or device number of said storage device and predetermined personal information of said one or more authorized users.

9. The method of claim 1, wherein said storage device comprises a portable personal storage device selected from the group consisting of a USB flash RAM, a hard disk drive storage device; a mobile telephone; a personal digital assistant; and a portable media player.

10. The method of claim 1, wherein, immediately prior to said downloading said selected one or more movie titles from said vendor computer system to said storage device, said vendor computer system validates registration of said storage device.

11. The method of claim 1, wherein said registering said one or more authorized users further comprises said vendor computer system establishing a connection to a credit reference agency to determine a credit worthiness of said one or more authorized users.

12. The method of claim 1, wherein said receiving a monetary payment by said vendor is effected by an electronic funds transfer payments system from a banking account or a mobile telephone account either before or after said vendor computer system downloads said selected one or more movie titles to said storage device.

13. The method of claim 1, wherein said vendor computer system is in communication with one or more vendor computer movie databases containing said plurality of available movie titles, and wherein said vendor computer movie database(s) is disposed at one or more locations remote from said vendor computer system.

14. The method of claim 1, wherein said storage device is connected to said vendor computer system via a wireless or a cable connection type comprising one or more of a USB connection, an IEEE 1394 FireWire connection, an infrared connection, and a radiofrequency (RF) connection.

15. The method of claim 14, wherein said RF connection comprises a microwave connection.

16. The method of claim 1, wherein said movie rental vendor is disposed one or more movie rental shops, and/or one or more self-serve kiosks disposed on third-party premises.

17. The method of claim 1, further comprising:
after said downloading, coupling said storage device to an input of a television display device for viewing of said downloaded movie title(s) over a predetermined period or a predetermined number of viewings thereof, and
playing said downloaded movie title(s) on said television display;

18. The method of claim 17, wherein said connecting said storage device directly to said television display device input comprises connecting said storage device to a DVD player and connecting said DVD player to said television display device input such that movie title(s) stored on said storage device are displayed on said television display device via said DVD player.

19. The method of claim 1, further comprising configuring said storage device to store data unrelated to said downloaded movie title(s) and/or to provide functions in addition to receiving, storing and displaying downloaded movie title(s).

20. A portable personal storage device configured for use in effecting the method of claim 1, wherein said storage device is configured to store data unrelated to said downloaded movie title(s) and/or to provide functions in addition to receiving, storing and displaying downloaded movie title(s).

21. A computer-readable medium containing computer readable instructions thereon which, when executed by a computer, carry out instructions for configuring a vendor computer system and/or a personal portable storage device to effect the method of claim 1.

22. A system for renting one or more movie titles in an electronic format from a movie rental vendor, the system comprising:
a vendor computer system;
means for registering said storage device and one or more associated authorized users with said vendor computer system and configuring a storage device to receive one or more movie titles in electronic format;
means for selecting one or more movie titles from a plurality thereof available for rent by said vendor;
means for downloading said selected one or more movie titles from said vendor computer system to said storage device; and
means for receiving a monetary payment by said vendor for said downloaded movie title(s), the magnitude of said payment depending on one or more of the downloaded movie title(s), a length of time of rental for each downloaded title(s), and a number of permitted viewings of each downloaded title.

23. The system of claim 22, further comprising means for connecting said storage device to an input of television display device for viewing of said downloaded movie title(s) over a predetermined period or a predetermined number of viewings thereof.

24. A method of renting information in an electronic format, the method comprising:
providing a vendor computer system;
registering a storage device operatively connected to the vendor computer system with said vendor computer system, said storage device being associated with one or more authorized users thereof,
registering said one or more authorized users with said vendor computer system and configuring said connected storage device to receive information in the electronic format;
at least one of said authorized users selecting one or more titles of information from a plurality thereof available for rent by said vendor;
downloading, in response to a selection by said at least one of said one or more authorized users, a selected one or more titles from said vendor computer system to said connected storage device; and
receiving a monetary payment by said vendor for said one or more downloaded titles, the magnitude of said payment depending on one or more of the downloaded titles, a length of time of rental for each of said one or more downloaded titles, and a number of permitted viewings of each of said one or more downloaded titles.

25. The method of claim 24, wherein said selected one or more titles comprise an e-book.

26. The method of claim 24, wherein said selected one or more titles comprise a movie title.

27. The method of claim 24, further comprising configuring said storage device to store data unrelated to said one or more downloaded titles and/or to provide functions in addition to receiving, storing and displaying selected one or more downloaded titles.

28. The method of claim 27, wherein said data unrelated to said one or more downloaded titles comprises a count of a number of times that information associated with the one or more downloaded titles has been accessed.

29. The method of claim 27, wherein said data unrelated to said one or more downloaded titles comprises a remaining period of time in which information associated with the one or more downloaded titles may be accessed.
